(19) United States
(12) Patent Application Publication
(10) Pub. No.: US 2024/0349165 A1
(43) Pub. Date: Oct. 17, 2024

(54) METHOD FOR SLICE RESOURCE RELEASE

(71) Applicant: ZTE CORPORATION, Shenzhen (CN)

(72) Inventors: Shuang LIANG, Shenzhen (CN); Menghan WANG, Shenzhen (CN); Jinguo ZHU, Shenzhen (CN)

(73) Assignee: ZTE CORPORATION, Shenzhen (CN)

(21) Appl. No.: 18/623,240

(22) Filed: Apr. 1, 2024

Related U.S. Application Data
(63) Continuation of application No. PCT/CN2022/073569, filed on Jan. 24, 2022.

(51) Int. Cl. H04W 40/22; H04W 40/12; H04W 48/18

(52) U.S. Cl. CPC H04W 40/22; H04W 40/12; H04W 48/18

(57) ABSTRACT

A wireless communication method is disclosed. The method comprises: receiving, by a policy control node from one or more network slice access control nodes, a notification indicating that a network slice is overloaded; and transmitting, by the policy control node to a wireless communication terminal, an updated User Equipment Route Selection Policy, URSP, or one or more offload rules to indicate the wireless communication terminal to re-match an application in association with the network slice to another network slice according to the notification.

### CROSS-REFERENCE TO RELATED PATENT APPLICATIONS

This application is a Continuation of PCT Application No. PCT/CN2022/073569, filed Jan. 24, 2022, incorporated herein by reference in its entirety.

### TECHNICAL FIELD

This document is directed generally to wireless communications, in particular to 5^{th} generation wireless communications.

### BACKGROUND

When a user equipment (UE) initiates to transfer data for an application, the UE matches the application with the UE Route Selection Policy (URSP) or the UE Local Configuration. When a Single-Network Slice Selection Assistant Information (S-NSSAI) is matched, the UE may initiate a registration procedure to request the S-NSSAI included in the requested Network Slice Selection Assistant Information (NSSAI). Upon a successful registration with an allowed NSSAI including the S-NSSAI, the UE may request a PDU session establishment procedure with the S-NSSAI.

### SUMMARY

This document relates to methods for slice resource release, devices thereof and systems thereof. In particular, this document relates to methods to offload some applications to a new slice, devices thereof and systems thereof. That is, in case that the slice resource is limited or the operator may replace the whole slice with a new slice, the network may determine and notify application offload to a new slice.

One aspect of the present disclosure relates to a wireless communication method comprising: receiving, by a policy control node from one or more network slice access control nodes, a notification indicating that a network slice is overloaded; and transmitting, by the policy control node to a wireless communication terminal, an updated User Equipment Route Selection Policy, URSP, or one or more offload rules to indicate the wireless communication terminal to re-match an application in association with the network slice to another network slice according to the notification.

Another aspect of the present disclosure relates to a wireless communication method comprising: receiving, by a wireless communication terminal from a policy control node, an updated User Equipment Route Selection Policy, URSP, or one or more offload rules; and re-matching, by the wireless communication terminal, an application from an overloaded network slice to another network slice according to the updated URSP or the one or more offload rules.

Another aspect of the present disclosure relates to a wireless communication method comprising: receiving, by a session management node from a network slice access control node, failed Single Network Slice Selection Assistance Information, S-NSSAI; and transmitting, by the session management node to a wireless communication terminal, one or more offload rules to indicate the wireless communication terminal to re-match an application in association with the failed S-NSSAI to a target network slice corresponding to another S-NSSAI.

Another aspect of the present disclosure relates to a wireless communication method comprising: receiving, by a wireless communication terminal from a session management node, one or more offload rules; and re-matching, by the wireless communication terminal, an application in associate with failed S-NSSAI to a target network slice corresponding to another S-NSSAI according to the one or more offload rules.

Another aspect of the present disclosure relates to a wireless communication node. In an embodiment, the wireless communication node includes a communication unit and a processor. The communication unit is configured to receive, from one or more network slice access control nodes, a notification indicating that a network slice is overloaded; and transmit, to a wireless communication terminal, an updated User Equipment Route Selection Policy, URSP, or one or more offload rules to indicate the wireless communication terminal to re-match an application in association with the network slice to another network slice according to the notification.

Another aspect of the present disclosure relates to a wireless communication terminal. In an embodiment, the wireless communication terminal includes a communication unit and a processor. The communication unit is configured to receive, from a policy control node, an updated User Equipment Route Selection Policy, URSP, or one or more offload rules; and the processor is configured to re-match an application from an overloaded network slice to another network slice according to the updated URSP or the one or more offload rules.

Another aspect of the present disclosure relates to a wireless communication node. In an embodiment, the wireless communication node includes a communication unit and a processor. The communication unit is configured to: receive from a network slice access control node, failed Single Network Slice Selection Assistance Information, S-NSSAI; and transmit, to a wireless communication terminal, one or more offload rules to indicate the wireless communication terminal to re-match an application in association with the failed S-NSSAI to a target network slice corresponding to another S-NSSAI.

Another aspect of the present disclosure relates to a wireless communication terminal. In an embodiment, the wireless communication terminal includes a communication unit and a processor. The communication unit is configured to receive, from a session management node, one or more offload rules. The processor is configured to: re-match an application in associate with failed S-NSSAI to a target network slice corresponding to another S-NSSAI according to the one or more offload rules.

Various embodiments may preferably implement the following features:

Preferably or in some embodiments, the method further comprises: adjusting, by the policy control node to the wireless communication terminal, an order of Single Network Slice Selection Assistance Information, S-NSSAI, in a Network Slice Selection Policy, NSSP.

Preferably or in some embodiments, the method further comprises: decreasing, by the policy control node to the wireless communication terminal, a priority of S-NSSAI corresponding to the overloaded network slice.

Preferably or in some embodiments, the method further comprises: removing, by the policy control node to the wireless communication terminal, S-NSSAI corresponding to the overloaded network slice from the NSSP.

Preferably or in some embodiments, the method further comprises: replacing, by the policy control node to the wireless communication terminal, S-NSSAI corresponding to the overloaded network slice in the NSSP with a new S-NSSAI.

Preferably or in some embodiments, the method further comprises: transmitting, by the policy control node to the wireless communication terminal, an indication for re-evaluating the updated URSP.

Preferably or in some embodiments, the indication is transparently transmitted to the wireless communication terminal via an Access and Mobility Management Function, AMF, in a URSP container.

Preferably or in some embodiments, the indication is non-transparently transmitted to the wireless communication terminal via an AMF.

Preferably, the one or more offload rules comprise S-NSSAI corresponding to a target network slice to indicate the wireless communication terminal to offload the application to the target network slice.

Preferably or in some embodiments, the target network slice is determined according to at least one of: configurations of the application and the target network slice; mapping information between the application and the target network slice; or a load of the target network slice.

Preferably or in some embodiments, S-NSSAI corresponding to the target network slice is in allowed Network Slice Selection Assistance Information, NSSAI.

Preferably or in some embodiments, the notification is received in response to reaching a threshold in association with the network slice.

Preferably or in some embodiments, the method further comprises: transmitting, by the policy control node to the one or more network slice access control nodes, a subscription request for the notification.

Preferably or in some embodiments, the subscription request comprises a threshold corresponding to a number of user equipments in association with the network slice.

Preferably or in some embodiments, the method further comprises: receiving, by the wireless communication terminal from the policy control node, an indication for re-evaluating the updated URSP.

Preferably or in some embodiments, the indication is transparently received from the policy control node via an Access and Mobility Management Function, AMF, in a URSP container.

Preferably or in some embodiments, the indication is non-transparently received from the policy control node via an AMF.

Preferably or in some embodiments, the application is re-matched from the overloaded network slice to the another network slice when the wireless communication terminal is in an idle mode or when there is no data transfer for the application.

Preferably or in some embodiments, the load of the target network slice is determined via a network data analytics function, NWDAF, or based on statistics of failure from a corresponding network slice access control node in a period of time.

Preferably or in some embodiments, the application is re-matched from the overloaded network slice to the another network slice when there is no data transfer for the application.

Preferably or in some embodiments, the application is re-matched from the overloaded network slice to the another network slice based on the one or more offload rules and a User Equipment Route Selection Policy, URSP.

The present disclosure relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows a schematic diagram of a network according to an embodiment of the present disclosure.

FIG. 2 shows a schematic diagram of a procedure according to an embodiment of the present disclosure.

FIG. 3 shows a schematic diagram of a procedure according to an embodiment of the present disclosure.

FIG. 4 shows a schematic diagram of a procedure according to an embodiment of the present disclosure.

FIG. 5 shows an example of a schematic diagram of a wireless terminal according to an embodiment of the present disclosure.

FIG. 6 shows an example of a schematic diagram of a wireless network node according to an embodiment of the present disclosure.

FIG. 7 to 10 show flowcharts of methods according to some embodiments of the present disclosure.

### DETAILED DESCRIPTION

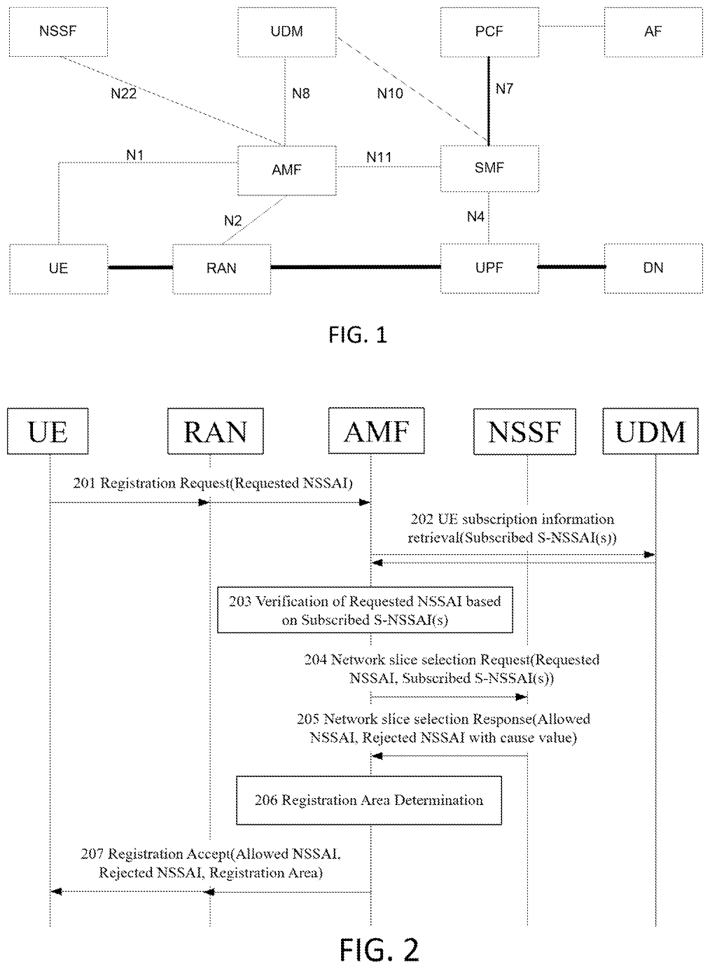

FIG. 1 shows a schematic diagram of a network (architecture) according to an embodiment of the present disclosure. In FIG. 1, the network (architecture) may comprise any of the following network functions (NFs).

In an embodiment, the network (architecture) comprises a User Equipment (UE), a Radio Access Network (RAN), and an Access and Mobility Management Function (AMF). The AMF NF includes functionalities such as UE Mobility Management, Reachability Management, Connection Management and Registration Management. The AMF terminates the RAN control plane (CP) interface N2 and Non-Access Stratum (NAS) interface N1, NAS ciphering and integrity protection. It also distributes the Session Management (SM) NAS to the proper Session Management Functions (SMFs) via N11 interface.

During Registration procedure, the AMF may determine the allowed NSSAI, the rejected NSSAI with rejection cause based on the requested NSSAI received from the UE. The AMF further determines the Registration Area within which the UE can use all S-NSSAIs of the allowed NSSAI. The AMF sends the allowed NSSAI, the rejected NSSAI with rejection cause and the Registration Area to the UE.

In an embodiment, the network (architecture) further comprises a Unified Data Management (UDM). The UDM manages the subscription profile for the UEs. The subscription data is stored in the Unified Data Repository (UDR). The subscription information includes the data used for Mobility Management and Session Management. The AMF and SMF retrieve the subscription data from the UDM.

In an embodiment, the network (architecture) further comprises Network Slice Selection Function (NSSF). The NSSF supports the following functionalities: selecting the set of Network Slice instances serving the UE; determining the allowed NSSAI and, if needed, the mapping to the Home Public Land Mobile Network (HPLMN) S-NSSAIs; determining the configured Network Slice Selection Assistant Information (NSSAI) and, if needed, the mapping to the HPLMN Single-Network Slice Selection Assistant Information (S-NSSAI); determining the AMF Set to be used to serve the UE, or, based on configuration, a list of candidate AMF(s), possibly by querying the Network Repository Function (NRF).

In the case of home-routed roaming, there may be two main options dependent on the operators' choices in terms of involvement of NRF, NSSF and configuration of AMF. One option is that HPLMN and Visitor Public Land Mobile Network (VPLMN) deploy the NSSF separately (called vNSSF and hNSSF).

In an embodiment, the network (architecture) further comprises a Session Management Function (SMF). The SMF includes the following functionalities: session establishment, modification and release, UE IP address allocation and management, selection and control of user plane (UP) function, etc.

In an embodiment, the network (architecture) further comprises a User Plane Function (UPF). The UPF serves as an anchor point for intra-/inter-radio access technology (RAT) mobility and as the external PDU session point of interconnect to the Data Network (DN). The UPF also routes and forwards the data packet according to the indication from the SMF. It also buffers the downlink (DL) data when the UE is in idle mode.

In an embodiment, the network (architecture) further comprises an Application Function (AF). The AF interacts with the 3GPP Core Network in order to provide services, for example to support application influence on traffic routing, accessing NEF, interacting with the policy framework for policy control, etc.

In an embodiment, the network (architecture) further comprises a Policy Control Function (PCF). The PCF supports unified policy framework to govern network behavior. The PCF provides access management policy to AMF, or session management policy to SMF, or UE policy to the UE. The PCF can access the UDR to obtain the subscription information relevant for policy decisions.

FIG. 2 shows a schematic diagram of a procedure according to an embodiment of the present disclosure. In this embodiment, a UE registration procedure to a set of Network Slices is shown. Specifically, the procedure shown in FIG. 2 comprises:

Step 201: When a UE registers over an Access Type with a PLMN, the UE may provide to the network in NAS layer, a Requested NSSAI containing the S-NSSAI(s) corresponding to the slice(s) to which the UE wishes to register.

The Requested NSSAI may be any one of:
The Default Configured NSSAI, i.e., if the UE has no configured NSSAI nor an allowed NSSAI for the serving PLMN;
The configured-NSSAI, or a subset thereof, e.g., if the UE has no Allowed NSSAI for the Access Type for the serving PLMN;
The allowed-NSSAI for the Access Type over which the requested NSSAI is sent, or a subset thereof; or
The allowed-NSSAI for the Access Type over which the requested NSSAI is sent, or a subset thereof, plus one or more S-NSSAIs from the configured-NSSAI not yet in the allowed NSSAI for the Access Type.

Step 202: When the AMF selected by the RAN during the registration procedure receives the UE registration request, the AMF may query the UDM to retrieve UE subscription information including the subscribed S-NSSAIs.

Step 203: The AMF verifies whether the S-NSSAI(s) in the requested NSSAI are permitted based on the subscribed S-NSSAIs. To identify the subscribed S-NSSAIs, the AMF may use the mapped HPLMN S-NSSAIs provided by the UE in the NAS message, for each S-NSSAI of the requested NSSAI.

Step 204: When the UE context in the AMF does not yet include an allowed NSSAI for the corresponding Access Type, the AMF queries the NSSF for network slice selection, except in the case when the AMF is allowed to determine whether it can serve the UE based on a configuration in this AMF. The IP address or FQDN of the NSSF is locally configured in the AMF.

Step 205: The NSSF returns to the AMF the allowed NSSAI. It may also return the rejected S-NSSAI(s) with rejection cause indicating the reason why the S-NSSAI(s) has been rejected, e.g., rejected NSSAI for the current PLMN, rejected NSSAI for the current registration area, etc.

Step 206: The serving AMF may determine a registration area such that all S-NSSAIs in the allowed NSSAI are available in all tracking areas of the registration area.

Step 207: The AMF sends a registration accept message to the UE including the allowed NSSAI and the mapped HPLMN NSSAI of the allowed NSSAI if provided, the rejected S-NSSAI(s) with rejection cause and the registration area.

After completion of the registration procedure, the UE may request to establish a PDU session. The requested S-NSSAI of the PDU session is derived from the URSP rules or UE local configuration. The requested S-NSSAI may be within the allowed NSSAI.

In an embodiment, the URSP is used by the UE to determine if a detected application can be associated to an established PDU Session or trigger the establishment of a new PDU Session based on the rules. Network Slice Selection Policy (NSSP) is the rules included in URSP and used by the UE to associate the matching application with S-NSSAI.

In various embodiments, mechanisms are provided to ensure applications offload to the new slice.

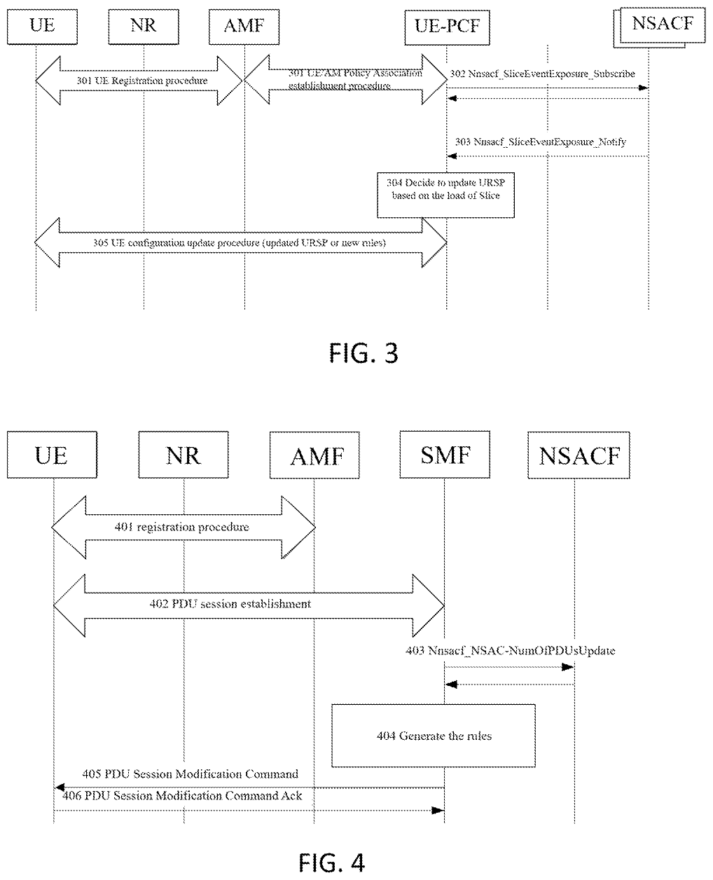

FIG. 3 shows a schematic diagram of a procedure according to an embodiment of the present disclosure. In this embodiment, the NSACF for the number of UEs or the number of PDU sessions per network slice may be the same or different.

In the non-roaming case, the AMF selects a PCF instance for AM policy association and selects the same PCF instance for UE policy association. In the roaming case, the AMF selects a V-PCF (Visitor PCF) instance for AM policy association and selects the same V-PCF instance for UE policy association. In FIG. 3 and the following description, the PCF or V-PCF may also be referred to as UE-PCF.

Specifically, the procedure shown in FIG. 3 comprises:

Step 301: The UE registers to the network and retrieves the allowed NSSAI. During the registration procedure, the AMF establishes AM Policy Association with the (V-)PCF by sending Npcf_AMPolicyControl_Create to the (V-)PCF. If NSACF is deployed for slice admission control, the message includes the allowed NSSAI and the associated NSACF. If multiple NSACFs are deployed in a network and one NSACF may be responsible for one or more S-NSSAIs in a service area, an S-NSSAI included in the allowed NSSAI may be associated with several NSACFs. The PCF maintains relationship of the UE, the S-NSSAI and NSACF(s).

Step 302: To subscribe or unsubscribe for the number of UEs per network slice notification with the NSACF, the PCF sends a Nnsacf_SliceEventExposure_Subscribe/Unsubscribe Request to the NSACF. The PCF can decide to subscribe one or more S-NSSAIs included in allowed NSSAI. If multiple NSACFs are deployed in a network for one S-NSSAI in a service area, the PCF may send more than one subscribe request to those NSACFs to retrieve slice status. The PCF can set the threshold in the request. When the threshold is reached, the NSACF sends a notification to the PCF.

Step 303: If the threshold is reached, the NSACF for a number of UEs per network slice sends a notification to the AM-PCF. In an embodiment, based on the implementation, after the NSACF sends the notification to the AM-PCF, if the load is below the threshold in a pre-configured time, the NSACF may send another notification to indicate that the corresponding network slice does not overload any more.

Step 304: Decide to update URSP based on the load of slice.

In an embodiment, based on the load information from the NSACF, the PCF can update the URSP as follows:
a. The PCF can adjust the order of S-NSSAI in the NSSP. The UE matches an application to a NSSP in that order. If there are more than one S-NSSAI matched with an application, the PCF may decrease the priority of overloaded S-NSSAI.
b. The PCF can remove the overloaded S-NSSAI in the NSSP, or replace the overloaded S-NSSAI with a new S-NSSAI.

The PCF may also include an indication to notify the UE to perform the re-evaluation immediately or when the UE enters idle mode.

The PCF can include such indication in the URSP container (this container is transparent for the AMF) or send such indication to the AMF (no transparent mode). If the AMF receives such indication, it forwards it to the UE

In an embodiment, based on the load information from the NSACF, the PCF can generate offload rules to the UE. Such rules indicate that some application (identified by a traffic descriptor matching a service data flow (SDF)) can be offload to another slice (identified by a S-NSSAI). The PCF may select the target S-NSSAI based on the configuration and the mapping information between the application and the slice. The PCF may also consider the load of the target S-NSSAI. The PCF may check whether the target S-NSSAI is included in the allowed NSSAI. The PCF can provide more than one rule in an order.

In this embodiment, there is no change of the URSP.

Step 305: The PCF provides the new rules or updated URSP to the UE via AMF.

In an embodiment, if the UE receives updated URSP with the re-evaluation indication (optional), the UE can re-evaluate the URSP immediately or re-evaluate the URSP when the UE enters idle mode.

In an embodiment, if the UE receives the offload rule, the UE may re-evaluate the application match based on the rules immediately or when there is no data transfer for such application(s).

FIG. 4 shows a schematic diagram of a procedure according to an embodiment of the present disclosure. Specifically, the procedure shown in FIG. 4 comprises:

Step 401: The UE registers to the network and retrieves the allowed NSSAI.

Step 402: The UE initiates the PDU session establishment procedure with the S-NSSAI included in allowed NSSAI.

Step 403: During the PDU session establishment procedure, the SMF anchors the PDU session triggers NSAC to the NSACF by sending Nnsacf_NSAC_NumOfPDUsUpdate_Request message. The SMF includes in the message the UE-ID, the PDU session ID, S-NSSAI for which the number of PDU sessions per network slice update is required, access type and the update flag, which indicates that the number of PDUs established on the S-NSSAI is to be increased.

The NSACF increases the current number of PDU sessions established on the S-NSSAI. The NSACF checks whether the maximum number of the PDU sessions established is reached. If the NSACF returned maximum number of PDU sessions per S-NSSAI reached result, the NSACF returns Nnsacf_NSAC_NumOfPDUsUpdate_Response message including a failed S-NSSAI list.

Step 404: If the S-NSSAI is included in the failed S-NSSAI list, the SMF generates a slice offload rule(s) to the UE to indicate some application (identified by a traffic descriptor matching a service data flow (SDF)) can be offloaded to another slice (identified by a S-NSSAI). The SMF selects the target S-NSSAI based on the configuration and the load of the target S-NSSAI. The SMF can analyze the load of an S-NSSAI via the NWDAF or statistics of the failure from NSACF in a period of time. The SMF can provide more than one rules in an order.

Step 405: The SMF provides a slice offload rule(s) to the UE via PDU session modification command message. When the UE receives the rule(s), the UE may re-evaluate the application match based on the rules and URSP immediately or when there is no data transfer for such application(s).

In this disclosure, a network slice relates to a logical network that provides specific network capabilities and network characteristics.

In this disclosure, a network slice instance relates to a set of Network Function (NF) instance and the required resources (e.g., compute, storage and networking resources) which form a deployed network slice.

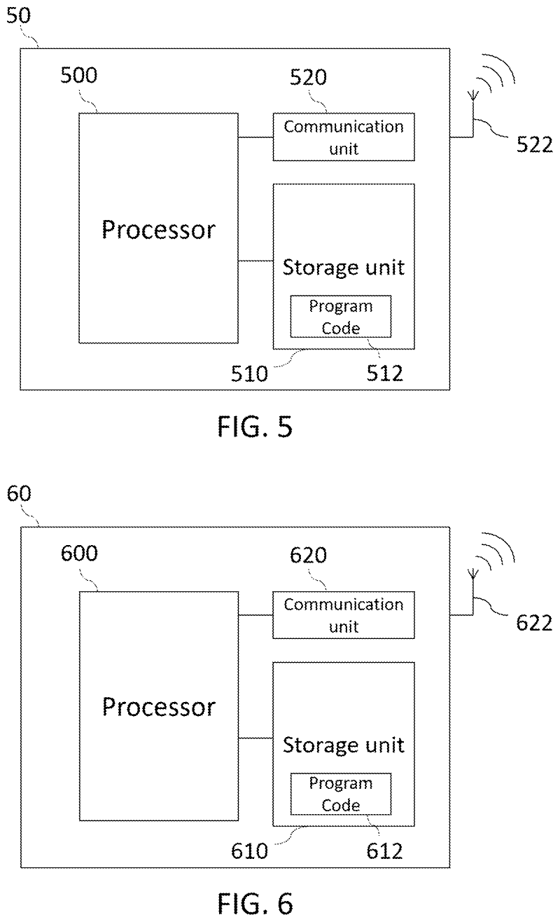

FIG. 5 relates to a schematic diagram of a wireless terminal 50 according to an embodiment of the present disclosure. The wireless terminal 50 may be a user equipment (UE), a mobile phone, a laptop, a tablet computer, an electronic book or a portable computer system and is not limited herein. The wireless terminal 50 may include a processor 500 such as a microprocessor or Application Specific Integrated Circuit (ASIC), a storage unit 510 and a communication unit 520. The storage unit 510 may be any data storage device that stores a program code 512, which is accessed and executed by the processor 500. Embodiments of the storage unit 512 include but are not limited to a subscriber identity module (SIM), read-only memory (ROM), flash memory, random-access memory (RAM), hard-disk, and optical data storage device. The communication unit 520 may a transceiver and is used to transmit and receive signals (e.g., messages or packets) according to processing results of the processor 500. In an embodiment, the communication unit 520 transmits and receives the signals via at least one antenna 522 shown in FIG. 5.

In an embodiment, the storage unit 510 and the program code 512 may be omitted and the processor 500 may include a storage unit with stored program code.

The processor 500 may implement any one of the steps in exemplified embodiments on the wireless terminal 50, e.g., by executing the program code 512.

The communication unit 520 may be a transceiver. The communication unit 520 may as an alternative or in addition be combining a transmitting unit and a receiving unit configured to transmit and to receive, respectively, signals to and from a wireless network node (e.g., a base station).

FIG. 6 relates to a schematic diagram of a wireless network node 60 according to an embodiment of the present disclosure. The wireless network node 60 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 60 may comprise (perform) at least one network function such as an access and mobility management function (AMF), a session management function (SMF), a user place function (UPF), a policy control function (PCF), an application function (AF), etc. The wireless network node 60 may include a processor 600 such as a microprocessor or ASIC, a storage unit 610 and a communication unit 620. The storage unit 610 may be any data storage device that stores a program code 612, which is accessed and executed by the processor 600. Examples of the storage unit 612 include but are not limited to a SIM, ROM, flash memory, RAM, hard-disk, and optical data storage device. The communication unit 620 may be a transceiver and is used to transmit and receive signals (e.g., messages or packets) according to processing results of the processor 600. In an example, the communication unit 620 transmits and receives the signals via at least one antenna 622 shown in FIG. 6.

In an embodiment, the storage unit 610 and the program code 612 may be omitted. The processor 600 may include a storage unit with stored program code.

The processor 600 may implement any steps described in exemplified embodiments on the wireless network node 60, e.g., via executing the program code 612.

The communication unit 620 may be a transceiver. The communication unit 620 may as an alternative or in addition be combining a transmitting unit and a receiving unit configured to transmit and to receive, respectively, signals to and from a wireless terminal (e.g., a user equipment or another wireless network node).

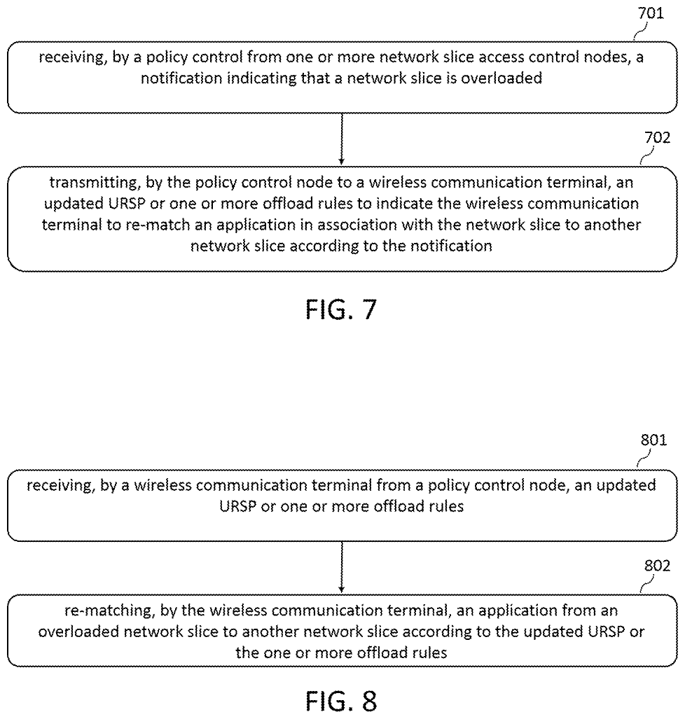

FIG. 7 shows a flowchart of a method according to an embodiment of the present disclosure. The method shown in FIG. 7 may be used in a UE-PCF (e.g., wireless network node/wireless device comprising the UE-PCF or wireless network node/wireless device performing at least part of functionalities of the UE-PCF) and comprises:

Step 701: Receiving, by a policy control node (e.g., UE-PCF) from one or more network slice access control nodes (e.g., NSACF), a notification (e.g., the notification in Step 303) indicating that a network slice is overloaded.

Step 702: Transmitting, by the policy control node to a wireless communication terminal (e.g., UE), an updated User Equipment Route Selection Policy, URSP, or one or more offload rules to indicate the wireless communication terminal to re-match an application in association with the network slice to another network slice according to the notification.

In this embodiment, the first notification indicates that the network slice is overloaded.

In an embodiment, the method further comprises: adjusting, by the policy control node to the wireless communication terminal, an order of Single Network Slice Selection Assistance Information, S-NSSAI, in a Network Slice Selection Policy, NSSP.

In an embodiment, the method further comprises: adjusting, by the policy control node to the wireless communication terminal, an order of Single Network Slice Selection Assistance Information, S-NSSAI, in a Network Slice Selection Policy, NSSP.

In an embodiment, the method further comprises: decreasing, by the policy control node to the wireless communication terminal, a priority of S-NSSAI corresponding to the overloaded network slice.

In an embodiment, the method further comprises: removing, by the policy control node to the wireless communication terminal, S-NSSAI corresponding to the overloaded network slice from the NSSP.

In an embodiment, the method further comprises: replacing, by the policy control node to the wireless communication terminal, S-NSSAI corresponding to the overloaded network slice in the NSSP with a new S-NSSAI.

In an embodiment, the method further comprises: transmitting, by the policy control node to the wireless communication terminal, an indication for re-evaluating the updated URSP.

In an embodiment, the indication is transparently transmitted to the wireless communication terminal via an Access and Mobility Management Function, AMF, in a URSP container.

In an embodiment, the indication is non-transparently transmitted to the wireless communication terminal via an AMF.

In an embodiment, the method further comprises: the one or more offload rules comprise S-NSSAI corresponding to a target network slice to indicate the wireless communication terminal to offload the application to the target network slice.

In an embodiment, the target network slice is determined according to at least one of: configurations of the application and the target network slice; mapping information between the application and the target network slice; or a load of the target network slice.

In an embodiment, S-NSSAI corresponding to the target network slice is in allowed Network Slice Selection Assistance Information, NSSAI.

In an embodiment, the notification is received in response to reaching a threshold in association with the network slice.

In an embodiment, the method further comprises: transmitting, by the policy control node to the one or more network slice access control nodes, a subscription request for the notification.

In an embodiment, the subscription request comprises a threshold corresponding to a number of user equipments in association with the network slice.

FIG. 8 shows a flowchart of a method according to an embodiment of the present disclosure. The method shown in FIG. 8 may be used in a UE (e.g., wireless network node/wireless device comprising the UE or wireless network node/wireless device performing at least part of functionalities of the UE) and comprises:

Step 801: Receiving, by a wireless communication terminal (e.g., UE) from a policy control node (e.g., PCF), an updated User Equipment Route Selection Policy, URSP, or one or more offload rules.

Step 802: Re-matching, by the wireless communication terminal, an application from an overloaded network slice to another network slice according to the updated URSP or the one or more offload rules.

In an embodiment, the method further comprises: receiving, by the wireless communication terminal from the policy control node, an indication for re-evaluating the updated URSP.

In an embodiment, the indication is transparently received from the policy control node via an Access and Mobility Management Function, AMF, in a URSP container.

In an embodiment, the indication is non-transparently received from the policy control node via an AMF.

In an embodiment, the one or more offload rules comprise S-NSSAI corresponding to a target network slice to indicate the wireless communication terminal to offload the application to the target network slice.

In an embodiment, the application is re-matched from the overloaded network slice to the another network slice when the wireless communication terminal is in an idle mode or when there is no data transfer for the application.

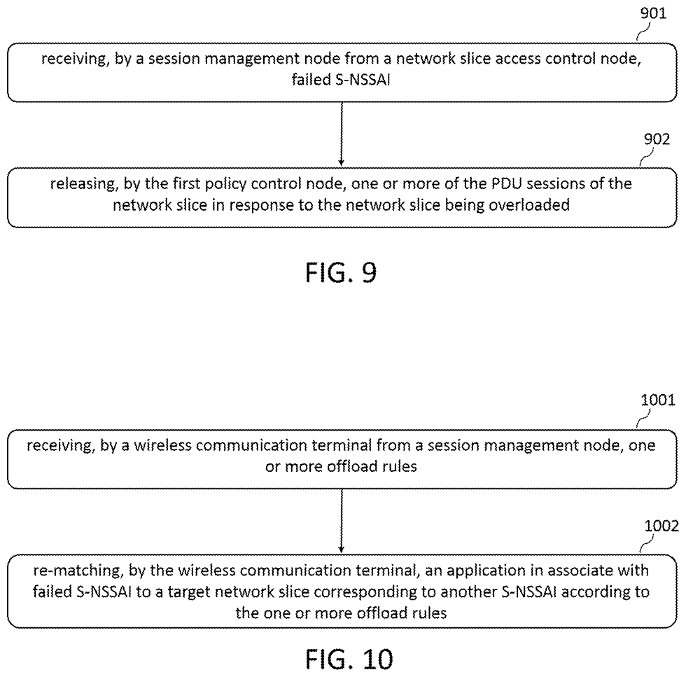

FIG. 9 shows a flowchart of a method according to an embodiment of the present disclosure. The method shown in FIG. 9 may be used in a SMF (e.g., wireless network node/wireless device comprising the SMF or wireless network node/wireless device performing at least part of functionalities of the SMF) and comprises:

Step 901: Receiving, by a session management node (e.g., SMF) from a network slice access control node (e.g., NSACF), failed Single Network Slice Selection Assistance Information, S-NSSAI.

Step 902: Releasing, by the first policy control node, one or more of the PDU sessions of the network slice in response to the network slice being overloaded.

In an embodiment, the one or more offload rules comprise S-NSSAI corresponding to the target network slice to indicate the wireless communication terminal to offload the application to the target network slice.

In an embodiment, the target network slice is determined according to at least one of: configurations of the application and the target network slice; mapping information between the application and the target network slice; or a load of the target network slice.

In an embodiment, the load of the target network slice is determined via a network data analytics function, NWDAF, or based on statistics of failure from a corresponding network slice access control node in a period of time.

FIG. 10 shows a flowchart of a method according to an embodiment of the present disclosure. The method shown in FIG. 10 may be used in a UE (e.g., wireless network node/wireless device comprising the UE or wireless network node/wireless device performing at least part of functionalities of the UE) and comprises:

Step 1001: Receiving, by a wireless communication terminal (e.g., UE) from a session management node (e.g., SMF), one or more offload rules.

Step 1002: Re-matching, by the wireless communication terminal, an application in associate with failed S-NSSAI to a target network slice corresponding to another S-NSSAI according to the one or more offload rules.

In this embodiment, the one or more offload rules comprise S-NSSAI corresponding to the target network slice to indicate the wireless communication terminal to offload the application to the target network slice.

In an embodiment, the application is re-matched from the overloaded network slice to the another network slice when there is no data transfer for the application.

In an embodiment, the application is re-matched from the overloaded network slice to the another network slice based on the one or more offload rules and a User Equipment Route Selection Policy, URSP.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method comprising:
receiving, by a policy control node from one or more network slice access control nodes, a notification indicating that a network slice is overloaded; and
transmitting, by the policy control node to a wireless communication terminal, an updated User Equipment Route Selection Policy (URSP), or one or more offload rules to indicate the wireless communication terminal to re-match an application in association with the network slice to another network slice according to the notification.

2. The wireless communication method of claim 1, further comprising:
adjusting, by the policy control node to the wireless communication terminal, an order of Single Network Slice Selection Assistance Information (S-NSSAI), in a Network Slice Selection Policy (NSSP);
wherein the wireless communication method further comprises:
decreasing, by the policy control node to the wireless communication terminal, a priority of S-NSSAI corresponding to the overloaded network slice;
removing, by the policy control node to the wireless communication terminal, S-NSSAI corresponding to the overloaded network slice from the NSSP; or
replacing, by the policy control node to the wireless communication terminal, S-NSSAI corresponding to the overloaded network slice in the NSSP with a new S-NSSAI.

3. The wireless communication method of claim 1, further comprising:
transmitting, by the policy control node to the wireless communication terminal, an indication for re-evaluating the updated URSP.

4. The wireless communication method of claim 3, wherein the indication is transparently transmitted to the wireless communication terminal via an Access and Mobility Management Function (AMF) in a URSP container.

5. The wireless communication method of claim 3, wherein the indication is non-transparently transmitted to the wireless communication terminal via an AMF.

6. The wireless communication method of claim 1, wherein the one or more offload rules comprise S-NSSAI corresponding to a target network slice to indicate the wireless communication terminal to offload the application to the target network slice.

7. The wireless communication method of claim 6, wherein the target network slice is determined according to at least one of:
configurations of the application and the target network slice;
mapping information between the application and the target network slice; or
a load of the target network slice.

8. The wireless communication method of claim 6, wherein S-NSSAI corresponding to the target network slice is in allowed Network Slice Selection Assistance Information, NSSAI.

9. The wireless communication method of claim 1, wherein the notification is received in response to reaching a threshold in association with the network slice.

10. The wireless communication method of claim 1, further comprising:
transmitting, by the policy control node to the one or more network slice access control nodes, a subscription request for the notification;
wherein the subscription request comprises a threshold corresponding to a number of user equipments in association with the network slice.

11. A wireless communication method comprising:
receiving, by a wireless communication terminal from a policy control node, an updated User Equipment Route Selection Policy (URSP), or one or more offload rules; and
re-matching, by the wireless communication terminal, an application from an overloaded network slice to another network slice according to the updated URSP or the one or more offload rules.

12. The wireless communication method of claim 11, further comprising:
receiving, by the wireless communication terminal from the policy control node, an indication for re-evaluating the updated URSP.

13. The wireless communication method of claim 12, wherein the indication is transparently received from the policy control node via an Access and Mobility Management Function (AMF) in a URSP container.

14. The wireless communication method of claim 12, wherein the indication is non-transparently received from the policy control node via an AMF.

15. The wireless communication method of claim 11, wherein the one or more offload rules comprise S-NSSAI corresponding to a target network slice to indicate the wireless communication terminal to offload the application to the target network slice.

16. The wireless communication method of claim 11, wherein the application is re-matched from the overloaded network slice to the another network slice when the wireless communication terminal is in an idle mode or when there is no data transfer for the application.

17. A wireless communication method comprising:
receiving, by a session management node from a network slice access control node, failed Single Network Slice Selection Assistance Information (S-NSSAI); and
transmitting, by the session management node to a wireless communication terminal, one or more offload rules to indicate the wireless communication terminal to re-match an application in association with the failed S-NSSAI to a target network slice corresponding to another S-NSSAI.

18. The wireless communication method of claim 17, wherein the one or more offload rules comprise S-NSSAI corresponding to the target network slice to indicate the wireless communication terminal to offload the application to the target network slice.

19. The wireless communication method of claim 17, wherein the target network slice is determined according to at least one of:
configurations of the application and the target network slice;
mapping information between the application and the target network slice; or
a load of the target network slice.

20. The wireless communication method of claim 19, wherein the load of the target network slice is determined via a network data analytics function (NWDAF), or based on statistics of failure from a corresponding network slice access control node in a period of time.
